(19) United States
(12) Patent Application Publication
(10) Pub. No.: US 2024/0380617 A1
(43) Pub. Date: Nov. 14, 2024

(54) TIMELINESS IN REMOTE ATTESTATION PROCEDURES

(71) Applicant: Nokia Technologies Oy, ESpoo (FI)

(72) Inventor: Ian Justin OLIVER, Espoo (FI)

(21) Appl. No.: 18/559,747

(22) PCT Filed: May 10, 2022
(86) PCT No.: PCT/EP2022/062601

§ 371 Date: Nov. 8, 2023

(30) Foreign Application Priority Data
May 11, 2021 (FI) 20215559

(51) Int. Cl. H04L 9/32; H04L 9/08

(52) U.S. Cl. CPC H04L 9/3297; H04L 9/0877

(57) ABSTRACT

There is provided an apparatus comprising means for: receiving, from an attestor, an entity attestation token comprising at least a claim data structure; transmitting a request to a security entity; generating a timestamp of transmission of the request to the security entity; including the timestamp of transmission of the request to the security entity to the claim data structure; receiving a response from the security entity; generating a timestamp of reception of the response from the security entity; including the timestamp of reception of the response from the security entity to the claim data structure; generating claim evidence for the entity attestation token; and transmitting a message to the attestor, wherein the message comprises at least: the claim evidence; the timestamp of transmission of the request to the security entity; and the timestamp of reception of the response from the security entity.

### FIELD

Various example embodiments relate to remote attestation procedures.

### BACKGROUND

Attestation or remote attestation refers to a service that allows a remote device such as a mobile phone, an Internet-of-Things (IoT) device, or other endpoint to prove itself to a relying party, a server or a service. State and characteristics of the remote device may be described by a set of claims which may be used by the relying party to determine a trust level of the remote device, i.e. how much the relying party trusts the remote device. In other words, remote attestation procedures (RATS) enable relying parties to decide whether to consider a remote device trustworthy or not.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising means for: receiving, from an attestor, an entity attestation token comprising at least a claim data structure; transmitting a request to a security entity; generating a timestamp of transmission of the request to the security entity; including the timestamp of transmission of the request to the security entity to the claim data structure; receiving a response from the security entity; generating a timestamp of reception of the response from the security entity; including the timestamp of reception of the response from the security entity to the claim data structure; generating claim evidence for the entity attestation token; and transmitting a message to the attestor, wherein the message comprises at least: the claim evidence; the timestamp of transmission of the request to the security entity; and the timestamp of reception of the response from the security entity.

According to a second aspect, there is provided an apparatus for an attestation procedure, comprising means for transmitting, to an attestee, an entity attestation token comprising at least a claim data structure; generating a first timestamp of transmission of the entity attestation token; receiving a message from the attestee, wherein the message comprises at least: claim evidence generated by the attestee; a second timestamp which is a timestamp of transmission of a request to a security entity by the attestee, wherein the timestamp is generated by the attestee; a third timestamp which is a timestamp of reception of a response by the attestee from the security entity, wherein the timestamp is generated by the attestee; and the apparatus comprises means for generating a fourth timestamp of reception of the message from the attestee; and verifying the attestation procedure by determining timeliness of the attestation procedure at least based on the first timestamp, the second timestamp, the third timestamp and the fourth timestamp.

According to a third aspect, there is provided a method for an attestation procedure, comprising: receiving, by an attestee from an attestor, an entity attestation token comprising at least a claim data structure; transmitting a request to a security entity; generating a timestamp of transmission of the request to the security entity; including the timestamp of transmission of the request to the security entity to the claim data structure; receiving a response from the security entity; generating a timestamp of reception of the response from the security entity; including the timestamp of reception of the response from the security entity to the claim data structure; generating claim evidence for the entity attestation token; and transmitting a message to the attestor, wherein the message comprises at least: the claim evidence; the timestamp of transmission of the request to the security entity; and the timestamp of reception of the response from the security entity.

According to an embodiment, the request to the security entity comprises a quote message to a trusted platform module.

According to an embodiment, the entity attestation token comprises a timestamp of transmission of the entity attestation token to an attestee, wherein the timestamp has been generated by the attestor.

According to a fourth aspect, there is provided a method for an attestation procedure, comprising: transmitting, by an attestor to an attestee, an entity attestation token comprising at least a claim data structure; generating a first timestamp of transmission of the entity attestation token; receiving a message from the attestee, wherein the message comprises at least: claim evidence generated by the attestee; a second timestamp which is a timestamp of transmission of a request to a security entity by the attestee, wherein the timestamp is generated by the attestee; a third timestamp which is a timestamp of reception of a response by the attestee from the security entity, wherein the timestamp is generated by the attestee; and the method comprises generating a fourth timestamp of reception of the message from the attestee; and verifying the attestation procedure by determining timeliness of the attestation procedure at least based on the first timestamp, the second timestamp, the third timestamp and the fourth timestamp.

According to an embodiment, determining timeliness of the attestation procedure comprises checking an order of time points indicated by the timestamps and comparing the order of the time points to a reference order; and in response to determining that the order of the time points does not correspond to the reference order, determining that the verification of the attestation procedure has been failed.

According to an embodiment, the reference order defines that the first timestamp indicates a time point which is before a time point indicated by the fourth timestamp; the second timestamp indicates a time point which is before a time point indicated by the third timestamp; the first timestamp indicates a time point which is before a time point indicated by the second timestamp; and/or the third timestamp indicates a time point which is before a time point indicated by the fourth timestamp.

According to an embodiment, the reference order defines a chronological order, wherein the first timestamp indicates an earliest time point and the fourth timestamp indicates a latest time point; and in response to determining that the time points are not in chronological order, determining that the verification of the attestation procedure has been failed.

According to an embodiment, the method comprises determining a duration of the attestation procedure based on the first timestamp and the fourth timestamp; if the duration of the attestation procedure is too short or too long based on predetermined thresholds, determining that verification of the attestation procedure has been failed.

According to an embodiment, the method comprises determining, based on the second timestamp and the third timestamp and predetermined thresholds, that the security entity has not been used by the attestee; determining that the verification of the attestation procedure has been failed.

According to an embodiment, the method comprises in response to determining that the verification of the attestation procedure has been failed, alerting a security orchestration component to establish one or more reasons of timeliness failure.

According to a further aspect, there is provided a non-transitory computer readable medium comprising program instructions that, when executed by at least one processor, cause an apparatus to at least to perform the method of the third aspect and any of the embodiments thereof, or the method of the fourth aspect and any of the embodiments thereof.

According to a further aspect, there is provided a computer program configured to cause the method of the third aspect and any of the embodiments thereof to be performed, or the method of the fourth aspect and any of the embodiments thereof to be performed.

### BRIEF DESCRIPTION OF THE DRAWINGS

FIG. 1 shows, by way of example, a system architecture, wherein an attestation procedure may be performed;

FIG. 2 shows, by way of example, signalling between an attestor, an attestee and a security entity;

FIG. 3 shows, by way of example, an attestation token comprising a claim data structure;

FIG. 4 shows, by way of example, a flowchart of a method;

FIG. 5 shows, by way of example, a flowchart of a method; and

FIG. 6 shows, by way of example, a block diagram of an apparatus.

### DETAILED DESCRIPTION

Remote attestation allows a relying party to know some characteristics about a device. Then, the relying party may decide, based on attestation result, whether it trusts the device. For example, the relying party may want to know whether a device will protect content provided to it. As another example, corporate enterprise may want to know whether a device is trustworthy before allowing the device access corporate data.

An entity attestation token (EAT) provides a set of claims and is cryptographically signed. The EAT may be a concise binary object representation (CBOR) web token (CWT) or JavaScript object notation (JSON) web token (JWT). Information items or elements in the token are referred to as claims. A claim may be considered as an item of data in the EAT, CWT or JWT that claims something about the device, such as its unique identifier (ID), manufacturer, model, installed software, device boot and debug state, geographic position location, versions of running software, measurements of running software, integrity checks of running software and/or nonce. Nonce is a cryptographic random number which may be sent by the relying party and returned as a claim to prevent replay and reuse. The set of claims may comprise a set of label-value pairs.

Claim set may be defined in a data structure. The EAT may comprise the data structure comprising a claim data structure. The data structure may comprise, for example, header, claim payload and a footer. Naming of the properties defined in the token may differ depending on implementation.

A relying party may transmit the attestation token (e.g. EAT) to an entity whose trust level the relying party wishes to determine. The relying party, that is the entity which transmits the attestation token may be referred to as an attestor. An entity or device whose trust level is to be determined, and which receives the attestation token may be referred to as an attestee.

In addition to the device proving its authenticity to the relying party, the relying party needs to be aware of timeliness of the attestation process. While authenticity may be considered as a proof of representation of the real state of a system or device, timeliness may be considered as a proof of representation of the current state of a system or device.

Timestamps may be used to verify the timeliness of the attestation process. Timestamps may be included in the claim data structure.

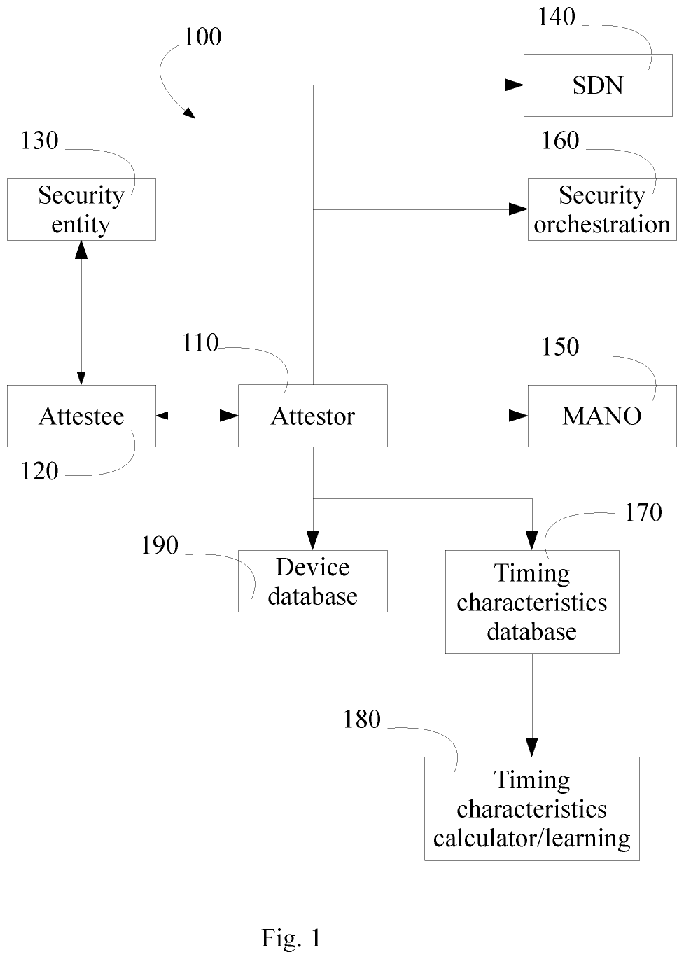

FIG. 1 shows, by way of example, a system architecture 100, wherein an attestation procedure may be performed. Gathering attestation data from devices, e.g. distributed devices over various networking technologies, may take varying amounts of time. The attestation process between an attestor 110 and an attestee 120 may take a period of time which is dependent upon a number of factors. When the attestor requests a claim from an attestee, a number of time points may be identified in the attestation process, such as: the start by the attestor, the receipt by the attestee, the finalization by the attestee and the final receipt by the attestor. For example, duration of the attestation process may depend on the amount of time it takes to obtain the claim, and/or the amount of time it takes by the attestee 120 to generate the claim evidence.

Attestee 120 may communicate with a security entity 130. Security entity or element is a device that can generate claims about their state, and are capable of reporting their trust status. The security entity is a device that may be used to validate system integrity by implementing an attestation protocol. The security entity enables a remote trustworthy assessment of the device's, e.g. the attestee's 120, software and hardware, for example. The security entity or module may comprise a trusted platform module (TPM). Other examples of security entities are a central processing unit (CPU) enclave and unified extensible firmware interface (UEFI) firmware. TPM provides a quoting mechanism for obtaining measurements of the platform. TPM may contain a set of platform configuration registers (PCRs). TPM quote operation may be used to authoritatively verify the contents of a TPM's PCRs.

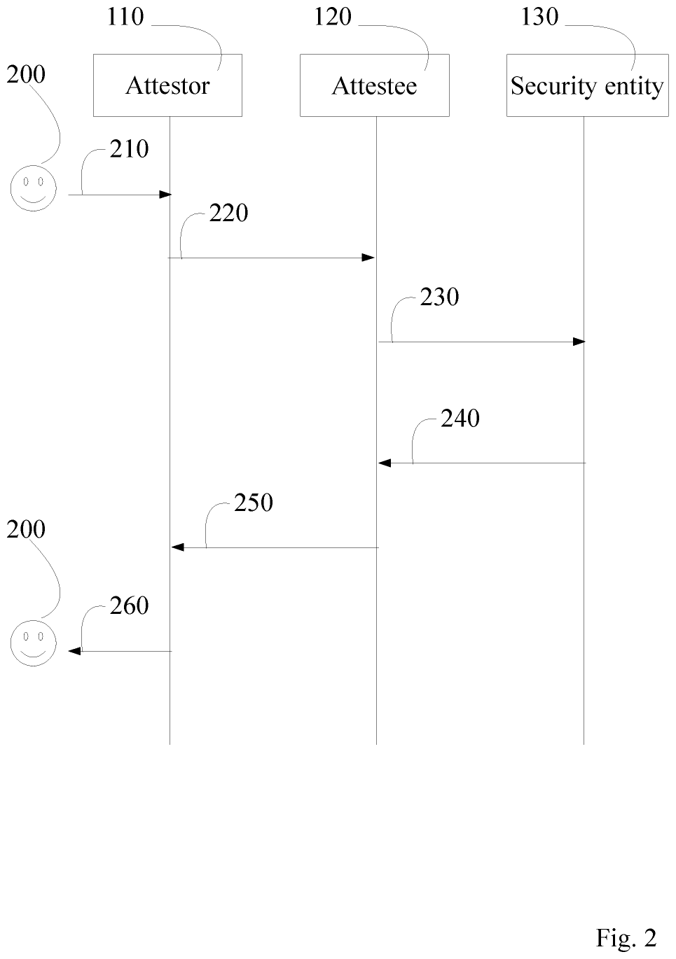

FIG. 2 shows, by way of example, signalling or interaction between an attestor 110, an attestee 120 and a security entity 130. Time advances from the top towards the bottom. The security entity 130 may comprise a TPM, for example.

An actor or administrator 200 is interested to determine trust status of a system. The actor 200 may request 210 the attestor 110 to perform an attestation procedure. Alternatively, the attestation procedure may be initiated by, for example, reboot of a device or element, an upgrade of certain parts of a device or element, a clock trigger, periodic trigger, a second device requesting the trust status of the first device, etc.

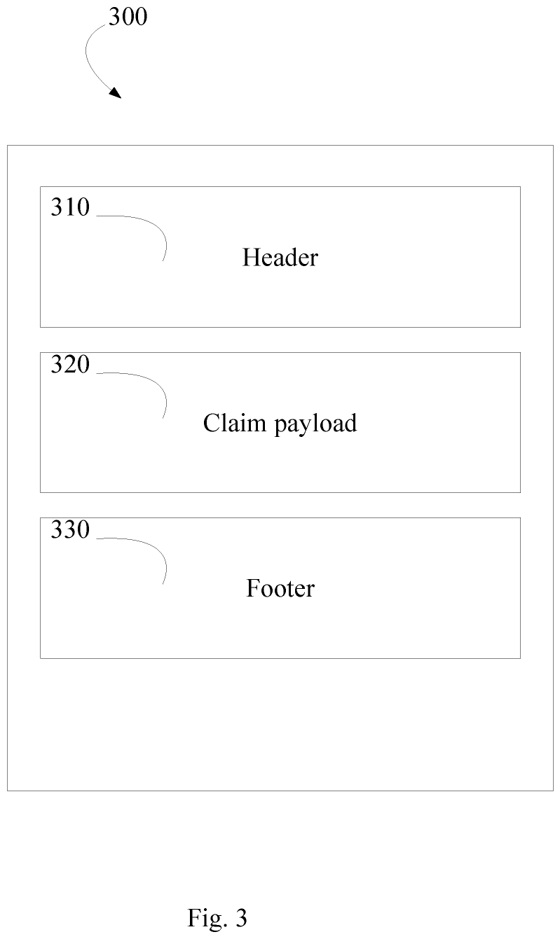

Attestor 110 transmits 220 “attest” message comprising an entity attestation token (EAT) to the attestee. The attestation token comprises at least a claim data structure. The attestation token may further comprise additional meta data and relevant signatures, for example. An example of an attestation token comprising a claim data structure is shown in FIG. 3. Upon transmission of the token, the attestor 220 may generate “TimeStamp_attest” indicating timestamp of the token, that is, a first timestamp. The first timestamp may be included in the claim data structure.

The attestee 120 receives the attestation token. The attestee 120 may then communicate with the security entity 130. For example, in case of TPM, the attestee 120 may perform the TPM quote operation. The attestee 120 may transmit 230 “getQuote” message to the security entity 130. The attestee 120 may generate “TimeStamp_getQuote” indicating timestamp of the “getQuote” message, that is, a second timestamp. This additional timestamp, the second timestamp, may be included in the claim data structure. The attestee may generate the claim evidence, that is, the evidence about its identity and integrity. The claim evidence is wrapped into the EAT.

The process of obtaining the claim may, in addition to the TPM quote operation, comprise other operations such as extracting a key from non-volatile random-access memory (NVRAM), setting up a CPU enclave to securely read a UEFI event log etc. The timing here may include additional aspects such as CPU enclave setup times.

Attestee 120 receives 240 “returnQuote” message from the security entity 130. The attestee 120 may generate “TimeStamp_returnQuote” indicating timestamp of the “returnQuote” message, that is, a third timestamp. This additional timestamp, the third timestamp, information may be included in the claim data structure.

Then, when the attestee 120 has generated evidence on claims in the claim data structure, the attestee 120 responds to the attestation token by transmitting 250 “returnClaim” message to the attestor 110.

The attestor 110 receives the “returnClaim” message as a response to the attestation token. The attestor 110 may generate “TimeStamp_retumClaim” indicating timestamp of the response, that is, a fourth timestamp. The fourth timestamp may be included in the claim data structure.

The time points or timestamps indicating the time points should have certain properties and order that is to be maintained. Namely, the following properties should hold:
1. TimeStamp_attest<TimeStamp_returnClaim (That is, time point of the TimeStamp_attest message is an earlier time point than the time point of the TimeStamp_returnClaim.)
2. TimeStamp_getQuote<TimeStamp_returnQuote
3. TimeStamp_attest<TimeStamp_getQuote
4. TimeStamp_returnQuote<TimeStamp_returnClaim

Timestamps for the starting point and ending point of the attestation process, that is “TimeStamp_attest” and “TimeStamp_returnClaim”, which are generated by the attestor, may be influenced by network or communication interactions, for example. “TimeStamp attest” may be a first timestamp. “TimeStamp_retumClaim” may be a fourth timestamp.

Timestamps generated by the attestee, that is, the “TimeStamp_getQuote” and “TimeStamp_returnQuote” may be influenced by the response from the security entity and machine load, for example. “TimeStamp_getQuote” may be a second timestamp. “TimeStamp_returnQuote” may be a third timestamp.

Chronological order of the timestamps from the earliest to the latest may be the following: 1. The first timestamp, 2. The second timestamp, 3. The third timestamp, 4. The fourth timestamp. If the order of the timestamps differs from this chronological order, it may indicate a problem with timeliness of the attestation procedure.

Above, an example with four timestamps has been described. The four timestamps may be related to a TPM quote operation. Structure of timestamps may be refined to include more information about further claim generation operations. A process for obtaining a claim may comprise a series of other operations, as well. For example, the following operations may be included for obtaining a claim:
StartTPMAuditingSession
GetQuote
GetUEFIEventLog
EndTPMAuditingSession
Sign an Verify Auditing Session

In this case, timestamps may be generated for the intermediate operations, e.g. for each of the intermediate operations. The timestamps of the operations of the above list should be in chronological order. These additional timestamps may be included in the claim, and the rules to verify and analyze the timestamps may be extended accordingly.

When the attestor 110 receives the “returnClaim” message, the attestor may check the claims according to normal procedures. For example, the attestor may check the syntax, signatures, payload, etc.

In addition, the attestor 110 may verify the attestation procedure by determining timeliness of the attestation procedure at least based on the first timestamp, the second timestamp, the third timestamp and the fourth timestamp. For example, the attestor 110 check whether the above properties on order of the timestamps hold.

Additionally or alternatively, the timing information may be processed by the attestor 110 as described below.

Bounds or threshold may be predetermined for the timestamps or timing values. The attestor is provided with the bounds. For example, it is known beforehand that TPM quote and signing takes approximately 0.75 seconds on a hardware device, and less than 0.01 seconds on a software implementation of a TPM. If implemented in a CPU enclave, the duration may be longer than 0.01 seconds. As an example, the timing characteristics of a device may be learned over time, and the expected values for bounds may be defined based on learned timing characteristics. The timing values may be affected e.g. by network latency, attestee CPU load, etc. This is why including additional information on timings of different parts of the claim to the claim is beneficial. In other words, the usage of additional timestamps is beneficial. If TimeStamp_attest and TimeStamp_returnClaim are outside of given bounds the claim may be noted as being potentially tampered with. For example, duration of the attestation procedure may be determined based on the timestamps. Threshold values may be determined for a suitable duration. If the attestation procedure has been too quick or too slow, it might imply that the claim or attestation procedure may have been tampered with. For example, if the claim or attestation procedure is too fast, it might suggest a man-in-the-middle (MITM) attack using replay or caching. MITM attack may also be known as machine-in-the-middle attack, for example. MITM attack is a cyberattack where an attacker relays and possibly alters communication between two parties who believe that they are directly communicating with each other. If the duration of the claims or attestation procedure is too long, it might indicate e.g. network congestion or similar tampering as MITM attack during the processing of the claim by the attestee.

If the TimeStamp_getQuote and TimeStamp_returnQuote are outside of given bounds, it might suggest that the security entity has not been used, or the secure module is under load which is too heavy, or the system overall is under load which is too heavy. Too long a time between the TimeStamp_getQuote and TimeStamp_returnQuote implies something interfering with the process. For example, this may be because of network latency, CPU usage or even multiple other processes using the TPM which may cause resource conflicts. Too short a time between the TimeStamp_getQuote and TimeStamp_returnQuote implies that something tries to impersonate a TPM or some process therein. In general, anything that differs from expected values may be a trigger for investigations.

Different manufacturers may use different implementation technologies so that a TPM from one manufacturer (X) might have different timing characteristics than a TPM from another manufacturer (Y). If an original equipment manufacturer (OEM) has stated that it has TPM from X in its models but timing characteristics are more akin to a TPM from Y, then this might be a trigger for investigations.

TPM, UEFI, CPU, or other secure element firmware may be upgraded. Upgrading may imply or cause different timing characteristics of key generation functions, for example. According to an example, TPM firmware version should be recorded in a TPM quote, but badly written firmware might not do this. Then, wrong bounds may be used for timing values which may lead to an alert and a trigger for investigations. Over time, updated bounds, e.g. lower bounds, may be established or learned. If the time stamps do not form a chronological set of timestamps, that is, if the order of the timestamps is not as expected as described above, it might suggest that there are clock and other timing issues between the attestor 110 and attestee 120. For example, there may be problems with network time protocol synching.

If network jitter has been detected, the attestor may request from a suitable management and orchestration component for information regarding network congestion. This might trigger changes to the acceptable timeliness bounds. For example, changes in network traffic, congestion and/or topology configuration may cause changes to the timing, bandwidth and latency characteristics of the network. The network changes may be a reason for a situation, wherein the request times for the sending/receiving of a claim may be too short/long/jittery.

For example, in a real-time system, the bounds may be defined with further hard constraints which might indicate that the claim is rejected regardless of the payload and signature. In other words, if the whole attestation procedure is not fast enough, it fails. For example, if a device does not report within a given time period then it may be assumed to be failing regardless of any subsequently received result. In some real-time systems, such as in a railway application, these kind of hard constraints and strict bounds are beneficial, since a delay of only a couple of seconds may cause an accident.

In the case of the attestee, or trustee, this warrants additional information about the state of the relying party, or trust agent, and how the system components there are running.

In some cases, too much jitter in the timing may suggest timing attacks, for example TPM-FAIL attack.

The attestor 110 may verify the attestation procedure by determining timeliness of the attestation procedure at least based on the first timestamp, the second timestamp, the third timestamp and the fourth timestamp. The attestor 110 may transmit 260 attestation result to the actor 200.

The attestor 110 may determined based on the timing information, whether the attestation process has failed. For example, failure of the attestation process may be determined based on the timing information independently of the claims.

Referring back to FIG. 1, the system 100 may comprise software defined networks (SDN) 140, management and orchestration (MANO) component 150, or other security orchestration components 160. If it may be determined based on the timing information that the attestation process has failed, the attestor 110 may, for example, alert SDN 140, MANO 150 and/or other security orchestration components 160, to establish reasons of timing characteristics failures.

FIG. 3 shows, by way of example, an attestation token 300 comprising a claim data structure. The data structure may comprise, for example, header 310, claim payload 320 and a footer 330. Header may comprise, for example, identification of signing algorithm, signing key, etc. Claim payload may comprise the claims as a set of label-value pairs. Footer may comprise, for example, the signature(s). The timestamps may be included in the header. Alternatively, the timestamps may be included in the payload, for example. In case of a TPM quote, there may be an additional timestamp in the quote itself, inside the payload.

Referring back to FIG. 1, the attestor 110 may, in addition to processing the claim timeliness information, collect the timing characteristics in a database, e.g. in a timing characteristic database 170. Employing the collected timing characteristics, the attestor 110 may develop via timing characteristics learning 180, a model of what is expected from different devices and networks. For example, the model may be based on a simple statistical model which may be created based on claims received over time. For example, if the claim timeliness constraints of a device fall outside of what is suggested by the model, then the device's behaviour needs to be checked. This may in turn change the acceptable verification rules that are applied. For example, if a device starts returning quotes outside of the expected constraints then the attestation server, or attestor 110, may put in to place rules for deeper forensics of the device. It may also remove the device temporarily from the current level of assurance, in the case of trust slicing, and notify MANO or other security orchestration components about this decision.

The attestor 110 may store information on what is expected from different device and network in a device database 190. The device database stores information on device characteristics.

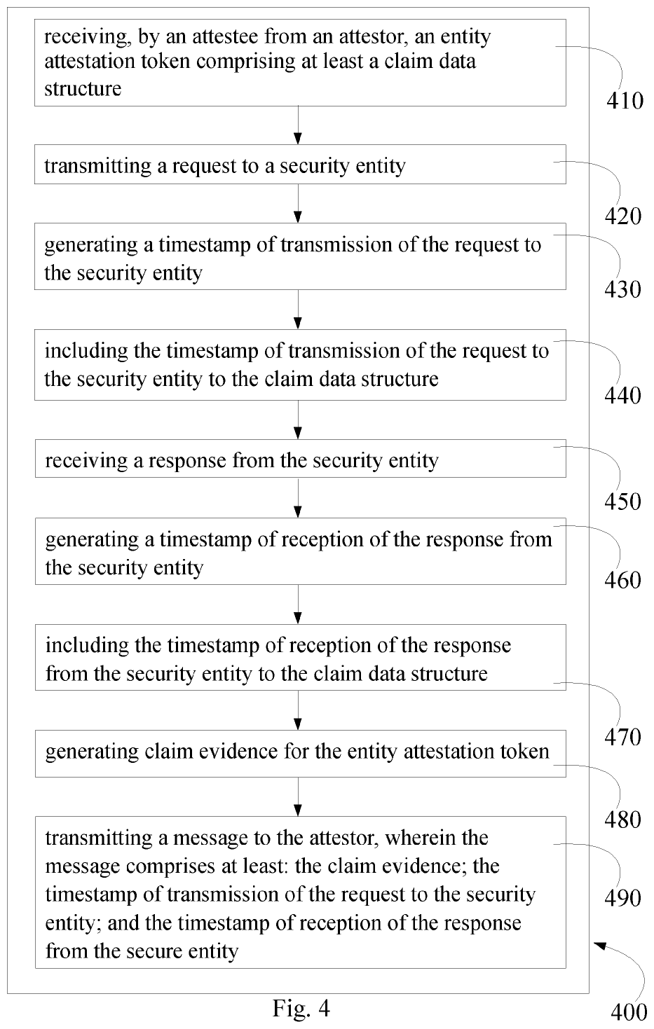

FIG. 4 shows, by way of example, a flowchart of a method 400. The method may be performed by an apparatus comprising an attestee, e.g. attestee 120 of FIG. 1 or FIG. 2, or in a control device configured to control functioning thereof when installed therein. The method 400 comprises receiving 410, by an attestee from an attestor, an entity attestation token comprising at least a claim data structure. The method 400 comprises transmitting 420 a request to a security entity. The method 400 comprises generating 430 a timestamp of transmission of the request to the security entity. The method 400 comprises including 440 the timestamp of transmission of the request to the security entity to the claim data structure. The method 400 comprises receiving 450 a response from the security entity. The method 400 comprises generating 460 a timestamp of reception of the response from the security entity. The method 400 comprises including 470 the timestamp of reception of the response from the security entity to the claim data structure. The method 400 comprises generating 480 claim evidence for the entity attestation token. The method 400 comprises transmitting 490 a message to the attestor, wherein the message comprises at least: the claim evidence; the timestamp of transmission of the request to the security entity; and the timestamp of reception of the response from the security entity.

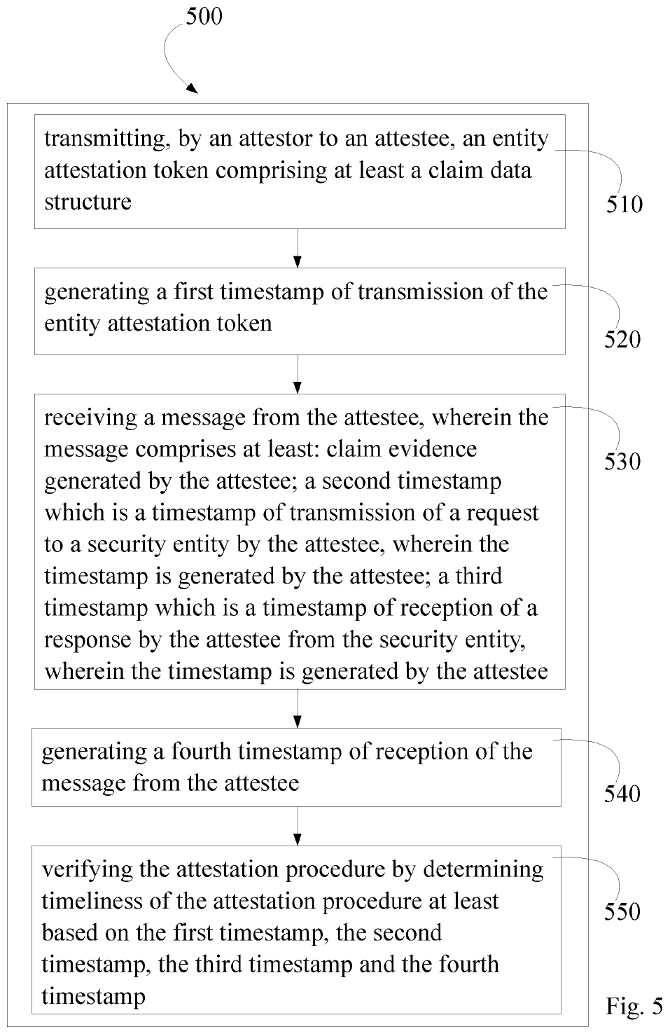

FIG. 5 shows, by way of example, a flowchart of a method 500. The method may be performed by an apparatus comprising an attestor, e.g. attestor 110 of FIG. 1 or FIG. 2, or in a control device configured to control functioning thereof when installed therein. The method 500 comprises transmitting 510, by an attestor to an attestee, an entity attestation token comprising at least a claim data structure. The method 500 comprises generating 520 a first timestamp of transmission of the entity attestation token. The method 500 comprises receiving 530 a message from the attestee, wherein the message comprises at least: claim evidence generated by the attestee; a second timestamp which is a timestamp of transmission of a request to a security entity by the attestee, wherein the timestamp is generated by the attestee; a third timestamp which is a timestamp of reception of a response by the attestee from the security entity, wherein the timestamp is generated by the attestee. The method 500 comprises generating 540 a fourth timestamp of reception of the message from the attestee. The method 500 comprises verifying 550 the attestation procedure by determining timeliness of the attestation procedure at least based on the first timestamp, the second timestamp, the third timestamp and the fourth timestamp.

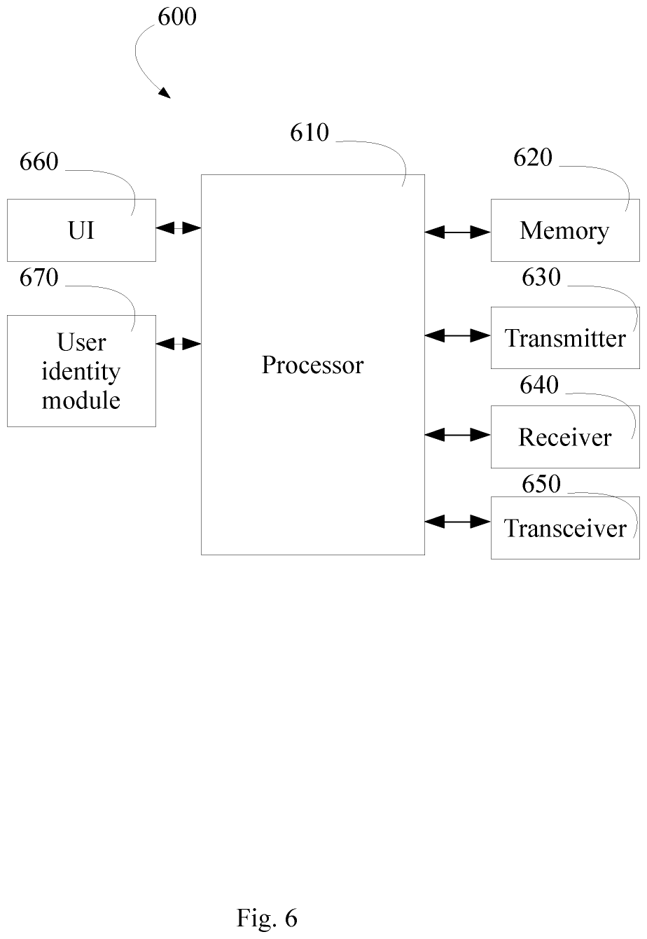

FIG. 6 shows, by way of example, a block diagram of an apparatus capable of performing methods discloses herein, e.g. the method 400 or the method 500. Illustrated is device 600, which may comprise, for example, an attestor 110 of FIG. 1 or FIG. 2, or an attestee 120 of FIG. 1 or FIG. 2. The attestor may comprise a server device. The attestee may be a user device, e.g. a mobile communication device such as a smart phone or an IoT device.

Comprised in device 600 is processor 610, which may comprise, for example, a single- or multi-core processor wherein a single-core processor comprises one processing core and a multi-core processor comprises more than one processing core. Processor 610 may comprise, in general, a control device. Processor 610 may comprise more than one processor. Processor 610 may be a control device. A processing core may comprise, for example, a Cortex-A8 processing core manufactured by ARM Holdings or a Steamroller processing core designed by Advanced Micro Devices Corporation. Processor 610 may comprise at least one Qualcomm Snapdragon and/or Intel Atom processor. Processor 610 may comprise at least one application-specific integrated circuit, ASIC. Processor 610 may comprise at least one field-programmable gate array, FPGA. Processor 610 may be means for performing method steps in device 600. Processor 610 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as an attestor or an attestee, or mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 600 may comprise memory 620. Memory 620 may comprise random-access memory and/or permanent memory. Memory 620 may comprise at least one RAM chip. Memory 620 may comprise solid-state, magnetic, optical and/or holographic memory, for example. Memory 620 may be at least in part accessible to processor 610. Memory 620 may be at least in part comprised in processor 610. Memory 620 may be means for storing information. Memory 620 may comprise computer instructions that processor 610 is configured to execute. When computer instructions configured to cause processor 610 to perform certain actions are stored in memory 620, and device 600 overall is configured to run under the direction of processor 610 using computer instructions from memory 620, processor 610 and/or its at least one processing core may be considered to be configured to perform said certain actions. Memory 620 may be at least in part external to device 600 but accessible to device 600.

Device 600 may comprise a transmitter 630. Device 600 may comprise a receiver 640. Transmitter 630 and receiver 640 may be configured to transmit and receive, respectively, information in accordance with at least one cellular or non-cellular standard. Transmitter 630 may comprise more than one transmitter. Receiver 640 may comprise more than one receiver. Transmitter 630 and/or receiver 640 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example. Entities of the system 100 in FIG. 1 may communicate with each other in accordance with at least one cellular or non-cellular standard.

Device 600 may comprise a near-field communication, NFC, transceiver 650. NFC transceiver 650 may support at least one NFC technology, such as NFC, Bluetooth, Wibree or similar technologies.

Device 600 may comprise user interface, UI, 660 or be coupled to UI. UI 660 may comprise at least one of a display, a keyboard, a touchscreen, a vibrator arranged to signal to a user by causing device 600 to vibrate, a speaker and a microphone. A user may be able to operate device 600 via UI 660, for example to accept incoming telephone calls, to originate telephone calls or video calls, to browse the Internet, to manage digital files stored in memory 620 or on a cloud accessible via transmitter 630 and receiver 640, or via NFC transceiver 650, and/or to play games.

Device 600 may comprise or be arranged to accept a user identity module 670. User identity module 670 may comprise, for example, a subscriber identity module, SIM, card installable in device 600. A user identity module 670 may comprise information identifying a subscription of a user of device 600. A user identity module 670 may comprise cryptographic information usable to verify the identity of a user of device 600 and/or to facilitate encryption of communicated information and billing of the user of device 600 for communication effected via device 600.

Processor 610 may be furnished with a transmitter arranged to output information from processor 610, via electrical leads internal to device 600, to other devices comprised in device 600. Such a transmitter may comprise a serial bus transmitter arranged to, for example, output information via at least one electrical lead to memory 620 for storage therein. Alternatively to a serial bus, the transmitter may comprise a parallel bus transmitter. Likewise processor 610 may comprise a receiver arranged to receive information in processor 610, via electrical leads internal to device 600, from other devices comprised in device 600. Such a receiver may comprise a serial bus receiver arranged to, for example, receive information via at least one electrical lead from receiver 640 for processing in processor 610. Alternatively to a serial bus, the receiver may comprise a parallel bus receiver.

Processor 610, memory 620, transmitter 630, receiver 640, NFC transceiver 650, UI 660 and/or user identity module 670 may be interconnected by electrical leads internal to device 600 in a multitude of different ways. For example, each of the aforementioned devices may be separately connected to a master bus internal to device 600, to allow for the devices to exchange information. However, as the skilled person will appreciate, this is only one example and depending on the embodiment various ways of interconnecting at least two of the aforementioned devices may be selected.

1-15. (canceled)

16. An apparatus comprising means for:
receiving, from an attestor, an entity attestation token comprising at least a claim data structure;
transmitting a request to a security entity;
generating a timestamp of transmission of the request to the security entity;
including the timestamp of transmission of the request to the security entity to the claim data structure;
receiving a response from the security entity;
generating a timestamp of reception of the response from the security entity;
including the timestamp of reception of the response from the security entity to the claim data structure;
generating claim evidence for the entity attestation token; and
transmitting a message to the attestor, wherein the message comprises at least
the claim evidence;
the timestamp of transmission of the request to the security entity; and
the timestamp of reception of the response from the security entity.

17. The apparatus of claim 16, wherein the request to the security entity comprises a quote message to a trusted platform module.

18. The apparatus of claim 16, wherein the apparatus comprises an attestee.

19. The apparatus of claim 16, wherein the entity attestation token comprises a timestamp of transmission of the entity attestation token to an attestee, wherein the timestamp has been generated by the attestor.

20. An apparatus for an attestation procedure, comprising means for
transmitting, to an attestee, an entity attestation token comprising at least a claim data structure;
generating a first timestamp of transmission of the entity attestation token;
receiving a message from the attestee, wherein the message comprises at least
claim evidence generated by the attestee;
a second timestamp which is a timestamp of transmission of a request to a security entity by the attestee, wherein the timestamp is generated by the attestee;
a third timestamp which is a timestamp of reception of a response by the attestee from the security entity, wherein the timestamp is generated by the attestee;
generating a fourth timestamp of reception of the message from the attestee; and
verifying the attestation procedure by determining timeliness of the attestation procedure at least based on the first timestamp, the second timestamp, the third timestamp and the fourth timestamp.

21. The apparatus of claim 20, wherein determining timeliness of the attestation procedure comprises checking an order of time points indicated by the timestamps and comparing the order of the time points to a reference order; and
in response to determining that the order of the time points does not correspond to the reference order, determining that the verification of the attestation procedure has been failed.

22. The apparatus of claim 21, wherein the reference order defines that
the first timestamp indicates a time point which is before a time point indicated by the fourth timestamp;
the second timestamp indicates a time point which is before a time point indicated by the third timestamp;
the first timestamp indicates a time point which is before a time point indicated by the second timestamp; and/or
the third timestamp indicates a time point which is before a time point indicated by the fourth timestamp.

23. The apparatus of claim 21, wherein the reference order defines a chronological order, wherein the first timestamp indicates an earliest time point and the fourth timestamp indicates a latest time point; and
in response to determining that the time points are not in chronological order, determining that the verification of the attestation procedure has been failed.

24. The apparatus of claim 20, further comprising means for
determining a duration of the attestation procedure based on the first timestamp and the fourth timestamp; if the duration of the attestation procedure is too short or too long based on predetermined thresholds,
determining that verification of the attestation procedure has been failed.

25. The apparatus of claim 20, further comprising means for
determining, based on the second timestamp and the third timestamp and predetermined thresholds, that the security entity has not been used by the attestee;
determining that the verification of the attestation procedure has been failed.

26. The apparatus of claim 20, further comprising means for in response to determining that the verification of the attestation procedure has been failed, alerting a security orchestration component to establish one or more reasons of timeliness failure.

27. The apparatus of claim 20, wherein the apparatus comprises an attestor.

28. The apparatus of claim 20, wherein the means comprises at least one processor; and at least one memory including computer program code, the at least one memory and the computer program code configured to, with the at least one processor, cause the performance of the apparatus.

29. A method for an attestation procedure, comprising:
receiving, by an attestee from an attestor, an entity attestation token comprising at least a claim data structure;
transmitting a request to a security entity;
generating a timestamp of transmission of the request to the security entity;
including the timestamp of transmission of the request to the security entity to the claim data structure;
receiving a response from the security entity;
generating a timestamp of reception of the response from the security entity;
including the timestamp of reception of the response from the security entity to the claim data structure;
generating claim evidence for the entity attestation token; and
transmitting a message to the attestor, wherein the message comprises at least
the claim evidence;
the timestamp of transmission of the request to the security entity; and
the timestamp of reception of the response from the security entity.
